(19) United States
(12) Patent Application Publication
(10) Pub. No.: US 2014/0022278 A1
(43) Pub. Date: Jan. 23, 2014

(54) CONTROL METHODS AND ELECTRONIC DEVICES

(71) Applicant: Lenovo (Beijing) Limited, Beijing (CN)

(72) Inventor: Cheng Guo, Beijing (CN)

(21) Appl. No.: 13/942,166

(22) Filed: Jul. 15, 2013

(30) Foreign Application Priority Data
Jul. 17, 2012 (CN) 201210247880.3

(51) Int. Cl. G09G 5/20

(52) U.S. Cl. CPC G09G 5/20
USPC 345/619

(57) ABSTRACT

The present disclosure discloses a control method and an electronic device. The method is applied in an electronic device including a display screen. The display screen has a first display effect and a second display effect different from the first display effect. The method includes: detecting whether there is a first trigger signal when the display screen is providing the first display effect; and controlling the display screen to provide the second display effect upon detecting the first trigger signal. The second display effect includes at least a first display sub-effect that presents on the display screen a virtual image symmetrical to an object in front of the display screen. According to the embodiments of the present disclosure, a display screen of an electronic device has a first display effect and a second display effect and can be switched from the first display effect to the second display effect in response to a trigger signal. When the display screen is providing the second display effect, it can be used as a mirror.

### TECHNICAL FIELD

The present disclosure relates to electronic technology, and more particularly, to control methods and electronic devices.

### BACKGROUND

Currently, an electronic display screen displays images captured by an electronic device or image information stored in an electronic device. In either case, the display screen is in an image display mode in which image information output from the electronic device is displayed on the display screen through a display unit based on display principles such as Liquid Crystal Display (LCD) or plasma.

However, a conventional display screen can only provide a single image display effect and cannot be controlled to provide different display effects to satisfy different requirements of users, which could be problematic.

### SUMMARY

It is an object of the present disclosure to provide a control method and an electronic device, capable of solving the above problem that a display screen can only provide a single image display effect and cannot be controlled to provide different display effects.

The above object is achieved by providing the following solutions.

According to a first solution of the present disclosure, a control method is provided. The control method is applied in an electronic device including a display screen. The display screen has a first display effect and a second display effect different from the first display effect. The method includes: detecting whether there is a first trigger signal when the display screen is providing the first display effect; and controlling the display screen to provide the second display effect upon detecting the first trigger signal. The second display effect includes at least a first display sub-effect that presents on the display screen a virtual image symmetrical to an object in front of the display screen.

In an embodiment, the second display effect further includes a second display sub-effect that is identical to the first display effect. The first display sub-effect corresponds to a first display area on the display screen and the second display sub-effect corresponds to a second display area on the display screen.

In an embodiment, the display screen includes an array of light emitting elements. The step of controlling the display screen to provide the second display effect includes: controlling a first set of light emitting elements in the array of light emitting elements to have a luminance value lower than a luminance threshold, such that the first display sub-effect is provided in the first display area on the display screen that corresponds to the first set of light emitting elements, and controlling a second set of light emitting elements in the array of light emitting elements to have a luminance value higher than the luminance threshold, such that the second display sub-effect is provided in the second display area on the display screen that corresponds to the second set of light emitting elements.

In an embodiment, the method further includes, after said controlling the display screen to provide the second display effect: displaying a first application identifier in the second display area on the display screen in which the second display sub-effect is provided.

In an embodiment, the electronic device further includes an array of capturing elements. The method further includes: obtaining parameter information of a target object using the array of capturing elements; and invoking a first application corresponding to the first application identifier based on the parameter information, such that a virtual image corresponding to the target object overlaps the identifier.

According to a second solution of the present disclosure, an electronic device is provided. The electronic device includes: a display screen having a first display effect and a second display effect different from the first display effect. The second display effect includes at least a first display sub-effect that presents on the display screen a virtual image symmetrical to an object in front of the display screen. The electronic device further includes: a trigger signal detection unit configured to detect whether there is a first trigger signal when the display screen is providing the first display effect; and a control unit configured to control the display screen to provide the second display effect upon detecting the first trigger signal.

In an embodiment, the second display effect further includes a second display sub-effect that is identical to the first display effect. The first display sub-effect corresponds to a first display area on the display screen and the second display sub-effect corresponds to a second display area on the display screen.

In an embodiment, the display screen includes an array of light emitting elements and the control unit is configured to control a first set of light emitting elements in the array of light emitting elements to have a luminance value lower than a luminance threshold, such that the first display sub-effect is provided in the first display area on the display screen that corresponds to the first set of light emitting elements, and control a second set of light emitting elements in the array of light emitting elements to have a luminance value higher than the luminance threshold, such that the second display sub-effect is provided in the second display area on the display screen that corresponds to the second set of light emitting elements.

In an embodiment, the control unit is further configured to: display a first application identifier in the second display area on the display screen in which the second display sub-effect is provided.

In an embodiment, the electronic device further includes an array of capturing elements configured to capture parameter information of a target object. The control unit is further configured to obtain parameter information of a target object using the array of capturing elements and invoke a first application corresponding to the first application identifier based on the parameter information, such that a virtual image corresponding to the target object overlaps the identifier.

According to the embodiments of the present disclosure, a display screen of an electronic device has a first display effect and a second display effect and can be switched from the first display effect to the second display effect in response to a trigger signal. When the display screen is providing the second display effect, it can be used as a mirror. In this way, it is possible to satisfy users' different display requirements on the display screen.

### BRIEF DESCRIPTION OF THE DRAWINGS

FIG. 1 is a flowchart of a method according to an embodiment of the present disclosure;

FIG. 2 is a flowchart of another method according to an embodiment of the present disclosure; and

FIG. 3 is a schematic diagram of a structure of an electronic device according to an embodiment of the present disclosure.

### DETAILED DESCRIPTION OF THE EMBODIMENTS

The embodiments of the present disclosure provide a control method and an electronic device to enable a display screen of the electronic device to be switched from a first display effect to a second display effect.

In the following, the embodiments of the present disclosure will be described in detail with reference to the figures.

The control method according to an embodiment of the present disclosure is applied in an electronic device including a display screen. The display screen has a first display effect and a second display effect different from the first display effect. The second display effect includes at least a first display sub-effect that presents on the display screen a virtual image symmetrical to an object in front of the display screen. In other words, the display area on the display screen in which the first display sub-effect is provided can function as a mirror.

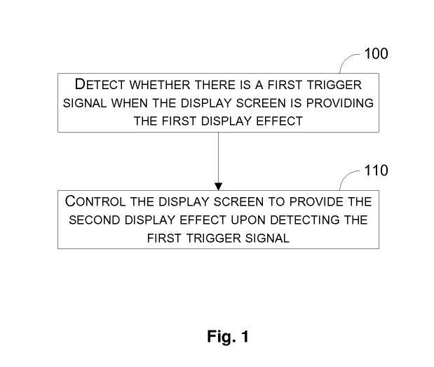

In particular, the method according to this embodiment includes the following steps, as shown in FIG. 1.

At step 100, it is detected whether there is a first trigger signal when the display screen is providing the first display effect.

At step 110, the display screen is controlled to provide the second display effect when the first trigger signal is detected.

According to this embodiment, a display screen of an electronic device has a first display effect and a second display effect and can be switched from the first display effect to the second display effect in response to a trigger signal. When the display screen is providing the second display effect, it can be used as a mirror. In this way, it is possible to satisfy users' different display requirements on the display screen.

Preferably, if no first trigger signal is detected, the display screen can be controlled to maintain its first display effect.

Preferably, when the display screen is providing the second display effect, it can be controlled to provide the first display effect if a second trigger signal is detected or if no first trigger signal has been detected for a predetermined time period.

In an embodiment, the display screen includes an array of light emitting elements (e.g., backlight elements in LCD screen) and the surface of the display screen is coated with a first material or a first film. When the luminance value of the light emitting elements is lower than a luminance threshold, the first display sub-effect is provided in its corresponding display area. That is, when the display screen is coated with the first material or the first film, it can function as a mirror. When the luminance value of the light emitting elements of the display screen is higher than a luminance threshold, an image display effect (i.e., the above first display effect) is provided in the display area corresponding to the display screen. Here, the image display effect refers to a display effect in which an image output from the electronic device is displayed on the display screen through a display unit (e.g., based on display principles such as Liquid Crystal Display (LCD) or plasma) in the display screen.

Preferably, the above step 100 can be implemented by detecting whether there is a target object within a predetermined distance range in front of the display screen and generating first trigger information when a target object is detected.

Alternatively, the above step 100 can be implemented by detecting whether there is a target object within a predetermined distance range in front of the display screen and whether the target object (if detected) stays in the predetermined distance range for a predetermined time period, and generating the first trigger information when there is a target object staying in the predetermined distance range for the predetermined time period.

Alternatively, the above step 100 can be implemented by detecting whether there is a target object within a predetermined distance range in front of the display screen and whether an image parameter of the target object (if detected) has changed, and generating the first trigger information when there is a target object within the predetermined distance range and the image parameter of the target object has changed.

The target object described above can be a user (a human). Further, the target object can be a user in clothes of a particular color or a user in clothes with a particular identifier (e.g., a barcode). In particular, a detector such as a sensor or a camera can be used to detect the target object and determine whether the target object satisfies the above condition. Accordingly, the image parameter of the target object, as described above, can be the color, shape or particular identifier of the clothes.

Further, after the target object is detected, it can be locked.

In an embodiment of the present disclosure, the first display effect can include the first display sub-effect only. In this case, the display screen providing the second display effect (i.e., the first display sub-effect) can function as a mirror. In particular, the luminance value of the array of light emitting elements in the display screen is controlled such that the first display sub-effect is provided in the display area on the display screen.

In an embodiment of the present disclosure, in addition to the first display sub-effect, the second display effect includes a second display sub-effect that is identical to the first display effect. The first display sub-effect corresponds to a first display area on the display screen and the second display sub-effect corresponds to a second display area on the display screen. In this case, when the display screen is providing the second display effect, in order to present the first display sub-effect in the first display area and the second display sub-effect in the second display area, the above step 110 can be implemented by controlling a first set of light emitting elements in the array of light emitting elements to have a luminance value lower than a luminance threshold, such that the first display sub-effect is provided in the first display area on the display screen that corresponds to the first set of light emitting elements, and controlling a second set of light emitting elements in the array of light emitting elements to have a luminance value higher than the luminance threshold, such that the second display sub-effect is provided in the second display area on the display screen that corresponds to the second set of light emitting elements. In other words, the display screen can function as a mirror in the first display area and can display the image information output from the electronic device in the second display area.

Accordingly, in another embodiment, when the display screen is controlled to provide the second display effect which includes the first and the second display sub-effects, the method further includes: displaying a first application identifier in the second display area on the display screen in which the second display sub-effect is provided. For example, the first application identifier can be a camera identifier which notifies the user that a camera function can be initiated at this moment. Alternatively, the first application identifier can be image information pre-stored in the electronic device which can provide the user with a recommendation on clothes matching or advertisement information.

Preferably, the electronic device can further include an array of capturing elements. In particular, the array of capturing elements can be used to capture parameter information of a target object. Accordingly, the method includes: obtaining parameter information of a target object using the array of capturing elements; and invoking a first application corresponding to the first application identifier based on the parameter information, such that a virtual image corresponding to the target object overlaps the identifier.

Here, the array of capturing elements can be an array of cameras or sensors distributed on the display screen, or an array of other capturing elements that can detect the parameter information of the target object.

When the array of capturing elements is an array of cameras distributed on the display screen, the parameter information of the target object it captures can be an image of the target object.

When the array of capturing elements is an array of sensors distributed on the display screen, the parameter information of the target object it captures can be information captured by one or more sensor corresponding to the virtual image of the target object presented on the display screen.

In particular, each capturing element in the array of capturing elements corresponds to one light emitting element in the array of light emitting elements. Thus, the electronic device can determine the size of the first display area in which the first display sub-effect is provided and the size of the second display area in which the second display sub-effect is provided, based on the size of the target object. Also, it is possible to dynamically adjust the first display area and the second display area based on the parameter information of the detected target object, such that the first application identifier can be displayed in an area on the display screen that overlaps the virtual image corresponding to the target object.

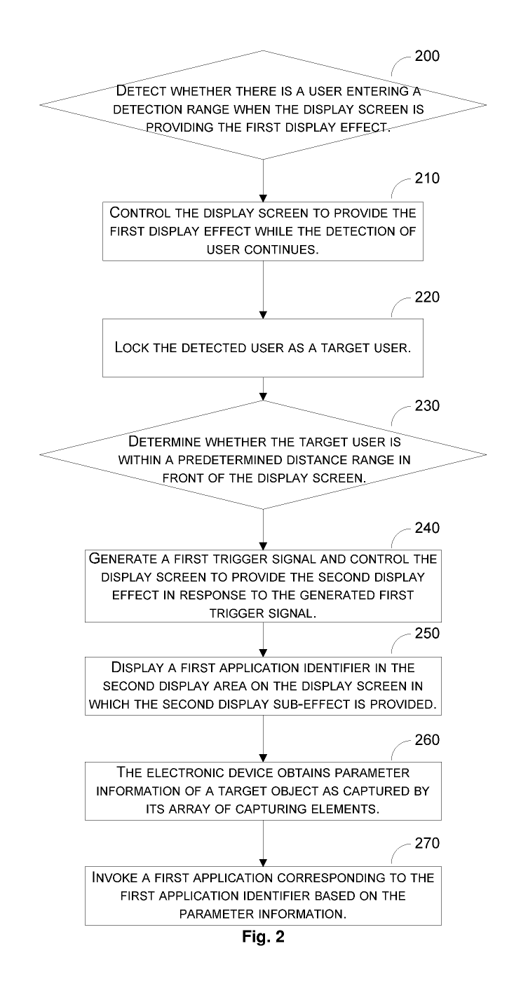

The method according to the present disclosure can be applied in a clothes shop. Accordingly, an electronic device can be provided in the shop and its display screen can replace the dressing mirror to be used by users. Normally, the display screen provides the first display effect for displaying the image output from the electronic device, including, for example, a live video picture of the shop captured by a camera of the electronic device, advertisement video information stored in the electronic device, information acquired from the Internet by the electronic device, or the like. Thus, the method according to the present disclosure can be applied in this application scenario. The process flow of the method includes the following operations, as shown in FIG. 2.

At step 200, when the display screen is providing the first display effect, it is detected whether there is a user entering a detection range. If so, the method proceeds with step 210; otherwise, it proceeds with step 220.

In particular, an image can be captured using a camera and then it is determined whether there is a user based on the captured image. Accordingly, the detection range means the range in which the camera captures images.

Alternatively, a sensor, such as an infrared sensor, can be used. If the sensor (e.g., infrared sensor) detects a signal, it can be determined that there is a user entering the detection range of the sensor.

At step 210, the display screen is controlled to provide the first display effect while the detection of user continues.

At step 220, the detected user is locked as a target user.

At step 230, it is determined whether the target user is within a predetermined distance range in front of the display screen. If not, the method proceeds with step 230; otherwise, it proceeds with step 240.

The predetermined distance range in front of the display screen can be set depending on actual application scenarios. For example, if it is desired to switch to the second display effect when the user is close to the display screen, the predetermined distance range can be set as a range from the display screen to a first distance threshold from the display screen. If it is desired to switch to the second display effect when the user is away from the display screen, the predetermined distance range can be set as a range from a second distance threshold from the display screen to a third distance threshold from the display screen.

At step 240, a first trigger signal is generated and the display screen is controlled to provide the second display effect in response to the generated first trigger signal.

It is assumed in this application scenario that the second display effect includes the first display sub-effect and the second display sub-effect. In particular, the step 240 can be implemented by controlling a first set of light emitting elements in the array of light emitting elements to have a luminance value lower than a luminance threshold, such that the first display sub-effect is provided in the first display area on the display screen that corresponds to the first set of light emitting elements, and controlling a second set of light emitting elements in the array of light emitting elements to have a luminance value higher than the luminance threshold, such that the second display sub-effect is provided in the second display area on the display screen that corresponds to the second set of light emitting elements. In other words, the display screen can function as a mirror in the first display area and can display the image information output from the electronic device in the second display area.

Further, a default partition of the first and the second display areas can be preconfigured. In this case, the first and the second display areas can be partitioned in accordance with the default partition in the step 240.

At step 250, a first application identifier is displayed in the second display area on the display screen in which the second display sub-effect is provided. In this application scenario, the first application identifier can be a camera identifier which notifies the user that a camera function can be initiated at this moment.

At step 260, the electronic device obtains parameter information of a target object as captured by its array of capturing elements.

Here, the array of capturing elements can be an array of cameras or sensors distributed on the display screen, or an array of other capturing elements that can detect the parameter information of the target object.

When the array of capturing elements is an array of cameras distributed on the display screen, the parameter information of the target object it captures can be an image of the target object.

When the array of capturing elements is an array of sensors distributed on the display screen, the parameter information of the target object it captures can be information captured by one or more sensor corresponding to the virtual image of the target object presented on the display screen.

At step 270, a first application corresponding to the first application identifier is invoked based on the parameter information.

In particular, the partition of the first and the second display areas can be adjusted based on the parameter information such that the location of the second display area can overlap the virtual image of the target object formed on the display screen. Accordingly, the first display sub-effect is presented in the adjusted first display area, the second display sub-effect is presented in the adjusted second display area, and the first application identifier is displayed on the second display area.

With the step 270, when a user stretch out his/her hand, he/she can see on the display screen a display effect that the virtual image of his/her hand presented on the display screen overlaps the first application identifier.

When the location of the parameter information of the target user as captured by the array of the capturing elements of the electronic device on the display screen overlaps the location of the first application identifier on the display screen, the camera function can be initiated to take a photo of the user.

In the above application scenario as an example, an electronic device can be provided in a shop and its display screen can replace the dressing mirror to be used by users. The display screen has a first display effect and a second display effect. Normally, the display screen provides the first display effect for displaying the image output from the electronic device, including, for example, a live video picture of the shop captured by a camera of the electronic device, advertisement video information stored in the electronic device, information acquired from the Internet by the electronic device, or the like.

When a user gets close to the display screen and needs a mirror to check the dressing effect of clothes he/she picks while the display screen is providing the first display effect, the electronic device will control the display screen to provide the second display effect in response to detection of the first trigger signal.

There are a number of schemes for generating the first trigger signal and detecting the first trigger signal by the electronic device, some of which will be given below as examples.

First, the electronic device captures images using a camera and detects a user by means of image analysis. If a user is detected, he/she is locked as a target user. Further, the electronic device captures images and monitors whether the target user is performing a particular action (such as checking clothes) or whether an image parameter of the target user has changed (e.g., detecting that the target user changes his/her clothes based on changes in color or style of clothes).

When it is detected that the target user performs the particular action or the image parameter has changed, a first trigger signal is generated and the display screen is controlled to provide the second display effect in response to the first trigger signal.

Second, the electronic device detects, by using an infrared sensor, whether there is a user entering the detection range of the infrared sensor. When a user enters the detection range of the infrared sensor, the user is locked as a target user. Then, it is monitored whether the target user is within a predetermined distance range from the display screen. When the target user is within the predetermined distance range, a first trigger signal is generated and the display screen is controlled to provide the second display effect in response to the first trigger signal.

The predetermined distance range in front of the display screen can be set depending on actual application scenarios. For example, if it is desired to switch to the second display effect when the user is close to the display screen, the predetermined distance range can be set as a range from the display screen to a first distance threshold from the display screen. If it is desired to switch to the second display effect when the user is away from the display screen, the predetermined distance range can be set as a range from a second distance threshold from the display screen to a third distance threshold from the display screen.

It is assumed that the second display effect includes the first display sub-effect and the second display sub-effect. The display screen includes an array of light emitting elements that is divided into two sets according to a default configuration: the first set of light emitting elements corresponding to the first display area and the second set of light emitting elements corresponding to the second display area. When switching to the second display effect, the electronic device controls a first set of light emitting elements to have a luminance value lower than a luminance threshold, such that the first display sub-effect is provided in the first display area on the display screen that corresponds to the first set of light emitting elements, and controls a second set of light emitting elements in the array of light emitting elements to have a luminance value higher than the luminance threshold, such that the second display sub-effect is provided in the second display area on the display screen that corresponds to the second set of light emitting elements. In other words, the display screen can function as a mirror in the first display area and can display the image information output from the electronic device in the second display area.

Further, the electronic device displays a first application identifier in the second display area. The first application identifier can be an identifier of a service the shop provides to its users. As non-limiting examples, the first application identifier can be an identifier identifying a camera function or a sharing function, or a menu identifier for a number of selectable functions.

When a user needs to trigger the first application identifier, he/she stretches out his/her hand. It is reasonable that the virtual image formed in the first display area on the display screen, which is created by the user's hand stretching action, overlaps the first application identifier in the second display area. Although the user does not actually touch the first application identifier on the display screen, he/she can see on the display screen a display effect as if his/her hand touches the first application identifier.

Accordingly, the electronic device further includes an array of capturing elements for capturing an action parameter of the target user.

Here, the array of capturing elements can be an array of cameras or sensors distributed on the display screen, or an array of other capturing elements that can detect the parameter information of the target object.

When the array of capturing elements is an array of cameras distributed on the display screen, the parameter information of the target object it captures can be an image of the target object.

When the array of capturing elements is an array of sensors distributed on the display screen, the parameter information of the target object it captures can be information captured by one or more sensor corresponding to the virtual image of the target object presented on the display screen.

The electronic device captures an action parameter indicating that the user stretches out his/her hand using the array of capturing elements, and invokes a first application corresponding to the first application identifier to adjust the location where the first application identifier is displayed, thereby achieving the above visual effect.

In particular, the electronic device detects user parameters such as the user's height and figure using the capturing elements and adjusts the partition of the first and the second display areas (i.e., the division of the first set of light emitting elements and the second set of light emitting elements) based on the detected user parameters. More specifically, the range on the display screen that can be covered by the user's hand stretching action can be determined based on the detected user parameters. The second display area can be determined within the range and the remaining area can be determined as the first display area. Then, the location of the second display is re-adjusted such that it can overlap the virtual image of the target object formed on the display screen. Accordingly, the first display sub-effect is presented in the adjusted first display area, the second display sub-effect is presented in the adjusted second display area, and the first application identifier is displayed on the second display area.

When the user stretches out his/her hand again, he/she can see on the display screen an effect that the virtual image of the hand formed on the display screen overlaps the first application identifier.

When the location of the parameter information of the target user as captured by the array of the capturing elements of the electronic device on the display screen overlaps the location of the first application identifier on the display screen, the function corresponding to the first application identifier (e.g., camera function, sharing function, or the like) can be initiated.

When the display screen is providing the second display effect, the electronic device can control the display screen to provide the first display effect if it detects a second trigger signal.

The second trigger signal can be generated when the user stretches out his/her hand to trigger the first application identifier in the second display area. For example, the first application identifier can be a menu icon. When the image formed on the display area, which is created by the user's hand stretching action, overlaps an icon in the menu for generating the second trigger signal, the second trigger signal is generated.

The second trigger signal can also be generated in response to the user leaving the distance range corresponding to the second display effect. In an example, the distance range corresponding to the second display effect is a range from a second distance threshold from the display screen to a third distance threshold from the display screen. When the user gets close to the display screen such that the distance between them is shorter than the second distance threshold, or the user moves away from the display screen such that the distance between them is longer than the third distance threshold, the electronic device detects that the user is out of the above distance range and thus generates the second trigger signal and controls the display screen to switch to the first display effect in response to the second trigger signal.

In the above application scenario as an example, an electronic device can be provided in a shop and its display screen can replace the dressing mirror to be used by users. The display screen has a first display effect and a second display effect. It is assumed that the second display effect includes only the first display sub-effect. In this case, the display screen can include an array of light emitting elements, or a single light emitting element only. When the display screen is providing the first display effect, the light emitting element(s) is/are controlled to have a luminance value higher than a luminance threshold, such that the display screen can display the image information output from the electronic device. When the display screen is providing the second display effect, the light emitting element(s) is/are controlled to have a luminance value lower than the luminance threshold, such that the display screen can function as a mirror.

Normally, the display screen provides the first display effect for displaying the image output from the electronic device, including, for example, a live video picture of the shop captured by a camera of the electronic device, advertisement video information stored in the electronic device, information acquired from the Internet by the electronic device, or the like.

When a user gets close to the display screen and needs a mirror to check the dressing effect of clothes he/she picks while the display screen is providing the first display effect, the electronic device will control the display screen to provide the second display effect in response to detection of the first trigger signal.

There are a number of schemes for generating the first trigger signal and detecting the first trigger signal by the electronic device, some of which will be given below as examples.

First, the electronic device captures images using a camera and detects a user by means of image analysis. If a user is detected, he/she is locked as a target user. Further, the electronic device captures images and monitors whether the target user is performing a particular action (such as checking clothes) or whether an image parameter of the target user has changed (e.g., detecting that the target user changes his/her clothes based on changes in color or style of clothes).

When it is detected that the target user performs the particular action or the image parameter has changed, a first trigger signal is generated and the display screen is controlled to provide the second display effect in response to the first trigger signal.

Second, the electronic device detects, by using an infrared sensor, whether there is a user entering the detection range of the infrared sensor. When a user enters the detection range of the infrared sensor, the user is locked as a target user. Then, it is monitored whether the target user is within a predetermined distance range from the display screen. When the target user is within the predetermined distance range, a first trigger signal is generated and the display screen is controlled to provide the second display effect in response to the first trigger signal.

The predetermined distance range in front of the display screen can be set depending on actual application scenarios. For example, if it is desired to switch to the second display effect when the user is close to the display screen, the predetermined distance range can be set as a range from the display screen to a first distance threshold from the display screen. If it is desired to switch to the second display effect when the user is away from the display screen, the predetermined distance range can be set as a range from a second distance threshold from the display screen to a third distance threshold from the display screen.

When the display screen is providing the second display effect, it can be controlled to provide the first display effect if a second trigger signal is detected or if no first trigger signal has been detected for a predetermined time period.

When the display screen is providing the second display effect, the electronic device can control the display screen to provide the first display effect if it detects a second trigger signal.

The second trigger signal can be generated when the user stretches out his/her hand to trigger the first application identifier in the second display area. For example, the first application identifier can be a menu icon. When the image formed on the display area, which is created by the user's hand stretching action, overlaps an icon in the menu for generating the second trigger signal, the second trigger signal is generated.

The second trigger signal can also be generated in response to the user leaving the distance range corresponding to the second display effect. In an example, the distance range corresponding to the second display effect is a range from a second distance threshold from the display screen to a third distance threshold from the display screen. When the user gets close to the display screen such that the distance between them is shorter than the second distance threshold, or the user moves away from the display screen such that the distance between them is longer than the third distance threshold, the electronic device detects that the user is out of the above distance range and thus generates the second trigger signal and controls the display screen to switch to the first display effect in response to the second trigger signal.

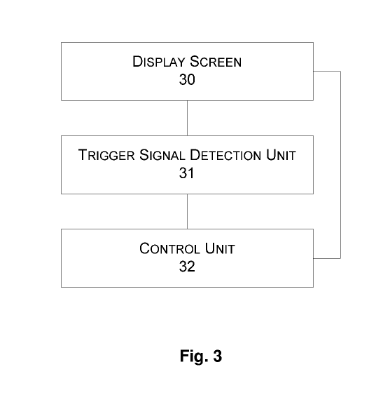

According to an embodiment of the present disclosure, an electronic device is also provided. The structure of the electronic device will be explained in the following with reference to FIG. 3.

The electronic device includes a display screen 30 having a first display effect and a second display effect different from the first display effect. The second display effect includes at least a first display sub-effect that presents on the display screen a virtual image symmetrical to an object in front of the display screen.

The electronic device further includes a trigger signal detection unit 31 configured to detect whether there is a first trigger signal when the display screen 30 is providing the first display effect.

The electronic device further includes a control unit 32 configured to control the display screen 30 to provide the second display effect when the trigger signal detection unit 31 detects the first trigger signal.

Preferably, the second display effect further includes a second display sub-effect that is identical to the first display effect. The first display sub-effect corresponds to a first display area on the display screen and the second display sub-effect corresponds to a second display area on the display screen.

Preferably, the display screen 30 includes an array of light emitting elements and the control unit 32 is configured to control a first set of light emitting elements in the array of light emitting elements to have a luminance value lower than a luminance threshold, such that the first display sub-effect is provided in the first display area on the display screen that corresponds to the first set of light emitting elements, and control a second set of light emitting elements in the array of light emitting elements to have a luminance value higher than the luminance threshold, such that the second display sub-effect is provided in the second display area on the display screen that corresponds to the second set of light emitting elements.

Preferably, the control unit 32 is further configured to: display a first application identifier in the second display area on the display screen 30 in which the second display sub-effect is provided.

Preferably, the electronic device further includes an array of capturing elements configured to capture parameter information of a target object. The control unit 32 is further configured to obtain parameter information of a target object using the array of capturing elements and invoke a first application corresponding to the first application identifier based on the parameter information, such that a virtual image corresponding to the target object overlaps the identifier.

While the preferred embodiments of the present disclosure have been described above, various modifications and variations can be made by those skilled in the art without departing from the spirit and scope of the present disclosure. Therefore, these modifications and variations, which fall into the scope of the claims as attached or equivalents thereof, are to be encompassed by the present disclosure.

What is claimed is:

1. A control method applied in an electronic device comprising a display screen, the display screen having a first display effect and a second display effect different from the first display effect, the method comprising:
detecting whether there is a first trigger signal when the display screen is providing the first display effect; and
controlling the display screen to provide the second display effect upon detecting the first trigger signal,
wherein the second display effect comprises at least a first display sub-effect that presents on the display screen a virtual image symmetrical to an object in front of the display screen.

2. The method of claim 1, wherein the second display effect further comprises a second display sub-effect that is identical to the first display effect, and
the first display sub-effect corresponds to a first display area on the display screen and the second display sub-effect corresponds to a second display area on the display screen.

3. The method of claim 2, wherein the display screen comprises an array of light emitting elements, and said controlling the display screen to provide the second display effect comprises:
controlling a first set of light emitting elements in the array of light emitting elements to have a luminance value lower than a luminance threshold, such that the first display sub-effect is provided in the first display area on the display screen that corresponds to the first set of light emitting elements, and
controlling a second set of light emitting elements in the array of light emitting elements to have a luminance value higher than the luminance threshold, such that the second display sub-effect is provided in the second display area on the display screen that corresponds to the second set of light emitting elements.

4. The method of claim 2, further comprising, after said controlling the display screen to provide the second display effect:
displaying a first application identifier in the second display area on the display screen in which the second display sub-effect is provided.

5. The method of claim 4, wherein the electronic device further comprises an array of capturing elements, and the method further comprises:
obtaining parameter information of a target object using the array of capturing elements; and
invoking a first application corresponding to the first application identifier based on the parameter information, such that a virtual image corresponding to the target object overlaps the identifier.

6. An electronic device, comprising:
a display screen having a first display effect and a second display effect different from the first display effect, the second display effect comprising at least a first display sub-effect that presents on the display screen a virtual image symmetrical to an object in front of the display screen;
a trigger signal detection unit configured to detect whether there is a first trigger signal when the display screen is providing the first display effect; and
a control unit configured to control the display screen to provide the second display effect upon detecting the first trigger signal.

7. The electronic device of claim 6, wherein the second display effect further comprises a second display sub-effect that is identical to the first display effect, and
the first display sub-effect corresponds to a first display area on the display screen and the second display sub-effect corresponds to a second display area on the display screen.

8. The electronic device of claim 7, wherein the display screen comprises an array of light emitting elements and the control unit is configured to:
control a first set of light emitting elements in the array of light emitting elements to have a luminance value lower than a luminance threshold, such that the first display sub-effect is provided in the first display area on the display screen that corresponds to the first set of light emitting elements, and
control a second set of light emitting elements in the array of light emitting elements to have a luminance value higher than the luminance threshold, such that the second display sub-effect is provided in the second display area on the display screen that corresponds to the second set of light emitting elements.

9. The electronic device of claim 7, wherein the control unit is further configured to:
display a first application identifier in the second display area on the display screen in which the second display sub-effect is provided.

10. The electronic device of claim 9, wherein the electronic device further comprises: an array of capturing elements configured to capture parameter information of a target object, and
the control unit is further configured to obtain parameter information of a target object using the array of capturing elements and invoke a first application corresponding to the first application identifier based on the parameter information, such that a virtual image corresponding to the target object overlaps the identifier.
